(19) United States
(12) Patent Application Publication
(10) Pub. No.: US 2025/0318973 A1
(43) Pub. Date: Oct. 16, 2025

(54) Standing Assist Device

(71) Applicant: Roger E. Kaufman, McLean, VA (US)

(72) Inventor: Roger E. Kaufman, McLean, VA (US)

(21) Appl. No.: 19/071,560

(22) Filed: Mar. 5, 2025

Related U.S. Application Data
(60) Provisional application No. 63/561,962, filed on Mar. 6, 2024.

(51) Int. Cl. A61G 7/10

(52) U.S. Cl. CPC A61G 7/1038; A61G 7/1044

(57) ABSTRACT

A standing assist device for assisting a user to stand up from a seated position includes a rear support frame and side support arms pivotably mounted on opposite widthwise sides of the rear support frame and defining 4-bar linkages. The rear support frame may be free-standing on a floor, or it may be attached to a floor or a wall or other support member. When the side support arms are in a lowered position, a seated user can grasp a front portion of the device to assist him in standing. A counterbalance mechanism can be provided to facilitate raising and lowering the side support arms. Legs which rest on the floor when the side support arms are in a lowered position may be pivotably connected to the front ends of the side support arms.

This application claims the benefit of U.S. Provisional Application No. 63/561,962 filed on Mar. 6, 2024, the disclosure of which is incorporated by reference.

### BACKGROUND OF THE INVENTION

This invention relates to a standing assist device for assisting a user in standing up from a seated position or sitting down from a standing position.

A variety of physical ailments can make it difficult for a person suffering from such ailments to stand up from a seated position or to lower himself from a standing position to a seated position. Examples of such ailments include knee problems, back problems, weakness after surgery, and general weakness due to aging.

A wide variety of standing assist devices are commercially available. Some examples of such devices are fixed grab bars for mounting on a bathroom wall adjoining a toilet, pivotable grab bars pivotably mounted on a bathroom wall to the rear of a toilet, handrails designed for mounting on a toilet itself, and poles which extend between the floor and the ceiling of a bathroom.

These conventional devices have numerous drawbacks. Wall-mounted grab bars are typically installed on only one side of a toilet, so a user is unable to use both arms when trying to stand up. Grab bars which are pivotably mounted on a wall behind a toilet and can pivot between a raised and a lowered position can apply large moments to the wall on which the grab bars are mounted, making the grab bars unsuitable for mounting on a wall of a typical wood-frame house, and they may only be suitable for use in institutional settings in buildings with concrete walls. Toilet-mounted handrails are usually positioned lower than the elbows of a user and require a user to push himself upwards when attempting to stand up, an action which can be difficult even for healthy users. Due to their low position, the handrails cannot support a user when the user is standing upright. Toilet-mounted handrails can also interfere with cleaning of a toilet. Floor-mounted poles can take up valuable floor space and interfere with access to a bathroom, especially if the user needs to use a walker. In addition, such poles can be difficult to safely install.

### SUMMARY OF THE INVENTION

The present invention provides a standing assist device which can aid a user in standing up from a seated position on a seat or in sitting down upon a seat from a standing position. The standing assist device can also be used to support a user while standing upright.

The present invention also provides an arrangement including a seat and a standing assist device.

The present invention also provides a method of using a standing assist device.

A standing assist device according to the present invention can be used with respect to a wide variety of seats, such as chairs, benches, stools, wheelchairs, toilet seats, sofas, beds, and examination and treatment tables at doctors' offices.

In a number of preferred embodiments, the standing assist device is free-standing with its entire weight resting on a floor. The standing assist device may also be attached to the floor, a wall, a chair, or other structure such as a support for a surface on which a user is seated.

A standing assist device according to the present invention is capable of being installed in a wide variety of locations, such as bedrooms, bathrooms, living rooms, or doctors' offices. It is also capable of being moved from one location to another when needed. For example, the same standing assist device without modification could be moved from one room of a house to another room as needed, such as from a living room to a bedroom, and used in a similar manner in each room.

In a typical method of using a standing assist device according to the present invention, a user pulls with his arms while standing up rather than having to push himself upwards. Much less strength is required by a user when standing up than with conventional grab bars which require a user to push himself up with his arms. In addition, portions of the standing assist device which are grasped by the user during the act of standing up are high enough for the standing assist device to support the user while fully erect, making it easier for the user to transition to a walker, a wheelchair, or a cane, if needed.

According to one form of the present invention, a standing assist device includes a rear support frame and first and second four-bar linkages disposed on opposite widthwise sides of the support frame and defining a space between the four-bar linkages in which a user of the device can sit. Each of the four-bar linkages includes first and second side support arms each pivotably connected to the rear support frame. The side support arms are pivotable with respect to the rear support frame between a raised position and a lowered position. A transverse connecting member capable of being grasped by a user may extend in a widthwise direction of the device between the four-bar linkages. The pivots of the four-bar linkages may be one degree-of-freedom joints, or they may have multiple degrees-of-freedom.

The standing assist device may include front legs which are each pivotably connected to the side support arms and form a portion of one of the four-bar linkages. The front legs contact a floor and support the four-bar linkages when the side support arms are in the lowered position. Alternatively, the front legs can be omitted, and structure can be provided to limit the rotation of the side support arms beyond the lowered position.

One or more of the rear support frame, the side support arms, and the front legs may have an adjustable length to enable the height or the geometry of the device to be modified.

### BRIEF DESCRIPTION OF THE DRAWINGS

FIG. 1 is an axonometric view of an embodiment of a standing assist device according to the present invention in a lowered position.

FIG. 2 is a side elevation of the embodiment of FIG. 1 in the lowered position.

FIG. 3 is an axonometric view of the embodiment of FIG. 1 in a partially raised position.

FIG. 4 is a side elevation of the embodiment of FIG. 1 in a further raised position.

FIG. 5 is a side elevation of the embodiment of FIG. 1 in a fully raised position.

FIG. 6 is an axonometric view of the embodiment of FIG. 1 in a fully raised position.

FIG. 7 is an enlarged side elevation of a portion of the embodiment of FIG. 1 showing by dashed lines the geometry of the four-bar linkage controlling the motion of the device.

FIGS. 8-11 schematically illustrate some effects of varying the geometry of the four-bar linkage in the embodiment of FIG. 1.

FIG. 12 is an enlarged axonometric view of a portion of the embodiment of FIG. 1 showing a counterbalance mechanism.

FIG. 13 is a schematic illustration of an example of a counterbalance mechanism employing a tension spring.

FIG. 14 is a schematic illustration of a portion of a counterbalance mechanism employing a spring reel.

FIG. 15 is a schematic illustration of a portion of a counterbalance mechanism employing a counterweight.

FIG. 16 is an axonometric view of a counterbalance mechanism which employs gas springs.

FIGS. 17 and 18 are axonometric views of a standing assist device equipped with the counterbalance mechanism of FIG. 16, with FIG. 17 showing the standing assist device in a lowered position and FIG. 18 showing the standing assist device in a fully raised position.

FIG. 19 is a schematic axonometric view of a modification of the standing assist device shown in FIG. 1 in which a transverse connecting member is secured to the front legs of the device, with the device shown in a lowered position.

FIG. 20 is a schematic axonometric view of the standing assist device of FIG. 19 in in a partially raised position.

FIG. 21 is a schematic axonometric view of the standing assist device of FIG. 19 in a fully raised position.

FIG. 22 is a side elevation of the standing assist device of FIG. 19 in the fully raised position.

FIG. 23 is a schematic axonometric view of an embodiment of a standing assist device according to the present invention from which the front legs of the embodiment of FIG. 1 have been omitted, with the device shown in a lowered position.

FIG. 24 is a side elevation of the standing assist device of FIG. 23 in the lowered position.

FIG. 25 is an enlarged side elevation of one of the stoppers of the standing assist device of FIG. 23.

FIG. 26 is a side elevation of the standing assist device of FIG. 23 in a partially raised position.

FIG. 27 is a schematic axonometric view of the standing assist device of FIG. 23 in a fully raised position.

FIG. 28 is a side elevation of an embodiment of a standing assist device according to the present invention having a rear frame which can be mounted on a wall and illustrating how the standing assist device might stabilize a user who had just used the device to stand up.

FIGS. 29-31 are axonometric views of the embodiment of FIG. 28 showing how the standing assist device can swing up to clear the user's head as the device is moved to a stowed position against the wall.

FIGS. 32-36 are schematic axonometric views showing an example of a typical method of using a standing assist device according to the present invention.

FIG. 37 is a schematic side elevation of a user preparing to stand up from a seated position using a standing assist device according to the present invention.

FIGS. 38 and 39 are schematic axonometric views of a user in a seated position and a standing position, respectively, with respect to a standing assist device according to the present invention.

FIG. 40 is an axonometric view showing the embodiment of FIG. 1 being used in conjunction with a sofa.

FIG. 41 is a schematic axonometric view showing the embodiment of FIG. 1 being used in conjunction with an examination table.

FIG. 42 is a schematic axonometric view showing the embodiment of FIG. 1 being used in conjunction with a wheelchair and a walker.

FIG. 43 is a front axonometric view of an embodiment of a standing assist device according to the present invention mounted on an easy chair.

FIG. 44 is a rear axonometric view of the embodiment of FIG. 43.

### DESCRIPTION OF EMBODIMENTS

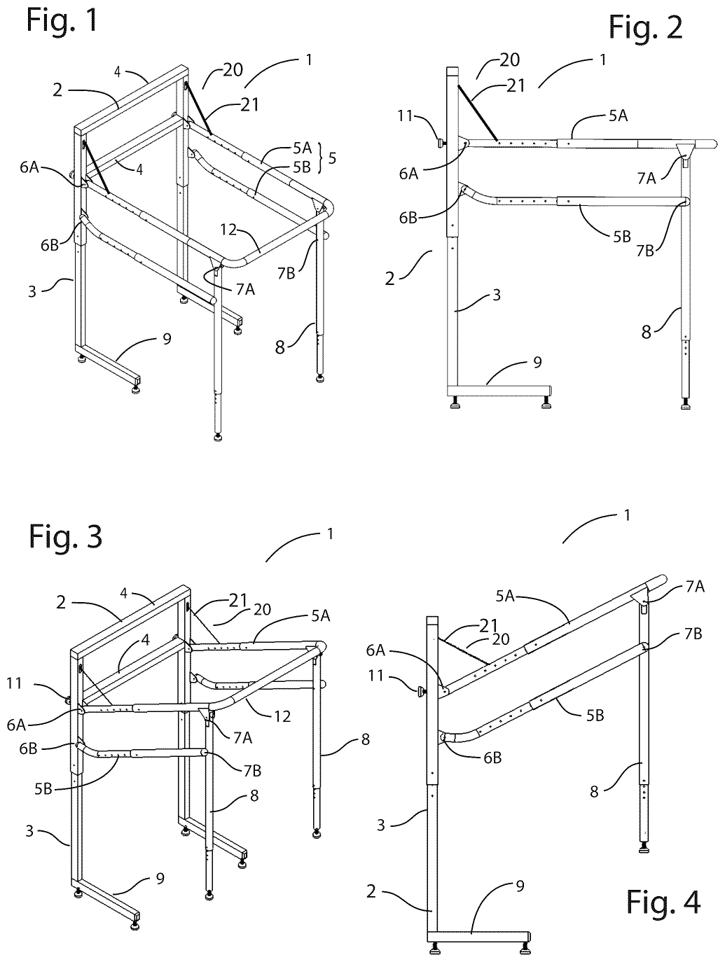

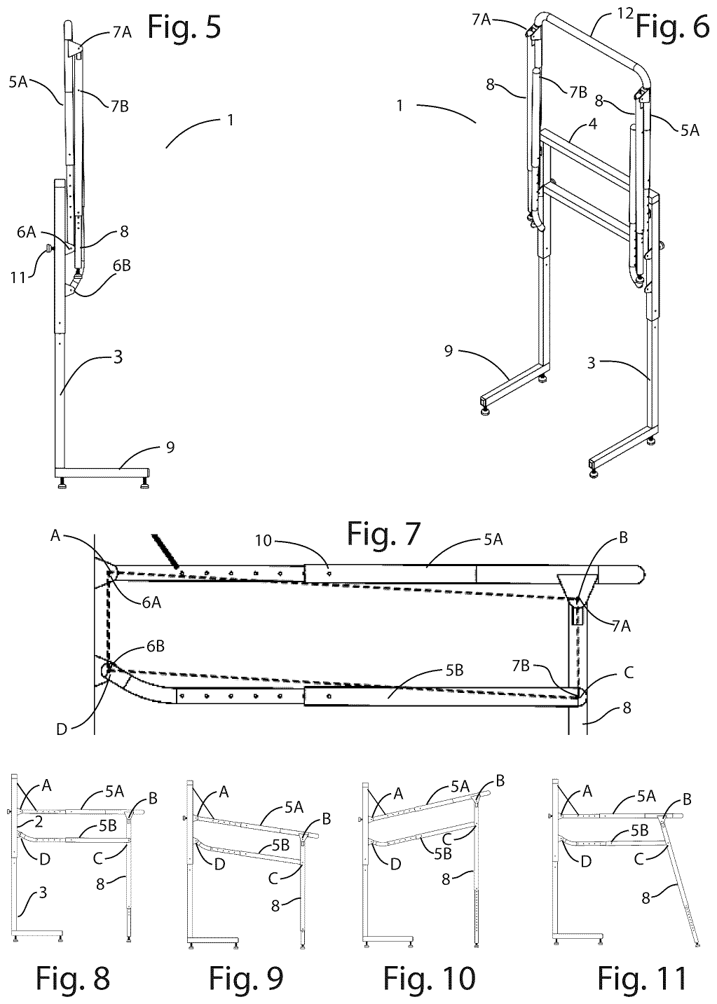

A number of embodiments of a standing assist device according to the present invention will be described while referring to the accompanying drawings. FIGS. 1-6 illustrate a first embodiment. FIG. 1 is an axonometric view of this embodiment in a lowered position, FIG. 2 is a side elevation of the embodiment of FIG. 1 in a lowered position, FIG. 3 is an axonometric view of this embodiment in a partially raised position, FIG. 4 is a side elevation of the embodiment of FIG. 1 in a somewhat further raised position, and FIGS. 5 and 6 are side and axonometric views, respectively, of the embodiment of FIG. 1 in a fully raised position. As shown in these figures, the standing assist device 1 in this embodiment includes a rigid rear support frame 2 which rests atop a floor or other support surface, which will be collectively referred to as a floor. The rear support frame 2 includes two upright legs 3 and one or more transverse members 4 extending in the widthwise direction of the rear support frame 2 and connecting the legs 3 with each other. Two pairs of side support arms 5 are pivotably mounted on opposite widthwise sides of the rear support frame 2. Each pair of side support arms 5 includes an upper side support arm 5A and a lower side support arm 5B disposed below the upper side support arm 5A. Each of the side support arms 5 has a rear end which is pivotably connected to the rear support frame 2 and a front end which is pivotably connected to a front leg 8. The side support arms 5 can be pivoted with respect to the rear support frame 2 between a lowered position shown in FIGS. 1 and 2 in which the lower end of each front leg 8 rests on the floor, and a fully raised position shown in FIGS. 5 and 6 in which the side support arms 5 and the front legs 8 are raised and stowed against the rear support frame 2. To stabilize the standing assist device, feet 9 which rest on the floor extend forwards from the lower ends of the legs 3 of the rear support frame 2.

The legs 3 of the rear support frame 2, the side support arms 5, and the front legs 8 may each have a fixed length. Alternatively, all or some of these members may have an adjustable length. In this embodiment, the legs 3 of the rear support frame 2, the side support arms 5, and the front legs 8 each have a telescoping structure including two sections which can be extended or contracted to adjust their length. The telescoping sections can be releasably fixed with respect to each other by typical mechanisms, such as set screws, removable pins, detent balls, or threaded engagement. For example, FIG. 7 shows an example in which pins 10 pass through holes in the outer sections of the side support arm 5A and 5B and matching holes in the inner sections and thereby lock the two sections together.

The standing assist device 1 may be installed with portions of the rear support frame 2 against a wall. In this embodiment, the entire weight of the standing assist device 1 itself and any vertical loads applied to the standing assist device 1 during use are transferred to the floor through the legs 3 of the rear support frame 2, so the wall does not need to carry any vertical loads resulting from the standing assist device 1. In addition, during use of the standing assist device 1, horizontal loads applied to the standing assist device 1 by a user are primarily compressive loads into the wall. Adjustable pads 11 may be installed on the rear of the rear support frame 2 such as in alignment with the upper side support arms 5A as shown in FIG. 2 to transmit horizontal loads to the wall. Therefore, the rear support frame 2 does not need to be secured to the wall. However, if desired, the rear support frame 2 may be anchored to the wall to maintain the standing assist device 1 in a desired position with respect to a seat with which the standing assist device 1 is to be used.

Each pair of side support arms 5A and 5B, the portion of the rear support frame 2 extending between the upper and lower side support arms 5A and 5B, and the portion of each front leg 8 extending between the upper and lower side support arms 5A and 5B to which it is connected define a four-bar linkage. FIGS. 7-11 illustrate various configurations of the four-bar linkage. As best seen in FIG. 7, point A indicates the pivot point 6A of the rear end of the upper side support arm 5A with respect to the rear support frame 2, point B indicates the pivot point 7A of the front end of the upper side support arm 5A with respect to the front leg 8, point C indicates the pivot point 7B of the front end of the lower side support arm 5B with respect to the front leg 8, and point D indicates the pivot point 6B of the rear end of the lower side support arm 5B with respect to the rear support frame 2. The dashed lines in FIG. 7 illustrate the basic geometry of this four-bar linkage. That geometry determines how the various parts move with respect to one another. The four-bar linkage on the opposite widthwise side of the standing assist device 1 may have the same geometry.

In the arrangements shown in FIGS. 7-10, the four-bar linkage is a parallelogram linkage, meaning that the quadrilateral defined by points ABCD is a parallelogram, with length AB equal to length CD, and with length AD equal to length BC. As a result, line AB is always parallel to line CD, and line AD is always parallel to line BC. FIG. 8 shows an example in which the side support arms 5A and 5B of the standing assist device 1 are substantially horizontal when the front legs 8 of the standing assist device 1 are resting on the floor. FIG. 9 shows an example in which the side support arms 5A and 5B slope downwards from the rear support frame 2 towards the front legs 8 when the front legs 8 are resting on the floor, and FIG. 10 shows an example in which the side support arms 5A and 5B slope upwards from the rear support frame 2 towards the front legs 8 when the front legs 8 are resting on the floor.

FIG. 11 shows an example in which the four-bar linkage is a trapezoidal linkage rather than a parallelogram linkage. Specifically, in this example, length BC is longer than length AD, length CD is longer than length AB, and the length of the front legs 8 is greater than the height from the floor to point A. As a result, when the front legs 8 are resting on the floor, they slope forwards and downwards rather than vertically. This configuration is useful when additional space is needed on the floor to avoid an obstruction such as furniture. Any of these configurations of the standing assist device 1 can be arranged by adjusting the lengths of the side support arms 5A and 5B, the lengths of the front legs 8, or the height of the rear support frame 2.

In FIGS. 8-11, the rear support frame 2, the side support arms 5A and 5B, and the front legs 8 are illustrated as being substantially linear over their length, but they are not restricted to any particular shape as long as the pivot points 6A, 6B, 7A, and 7B define a four-bar linkage in which the side support arms 5A and 5B can pivot up and down with respect to the rear support frame 2. For example, they can be straight over their entire length, curved over their entire length, or have a combination of straight and curved portions. In the embodiment shown in FIG. 1, each of the upper side support arms 5A is straight over its entire length, but pivot point 7A is offset from the centerline of the upper side support arm 5A, while each of the lower side support arms 5B is straight over most of its length but has a curved portion near its rear end where it is connected to the rear support frame 2 at pivot point 6B. The curved portions of the lower side support arms 5B prevent the lower side support arms 5B from interfering with the upper side support arms 5A when the side support arms 5A and 5B are in a fully raised position and also allow the front portions of the lower side support arms 5B to remain parallel with the upper side support arms 5A.

In FIGS. 7-11, the rear pivot points 6A and 6B are located near the extreme rear ends of the side support arms 5A and 5B, and the front pivot points 7A and 7B are located near the extreme front ends of the side support arms 5A and 5B. However, as long as the pivot points define a four-bar linkage, it is possible for the rear ends of the side support arms 5A and 5B to extend to the rear of the rear pivot points 6A and 6B and for the front ends of the side support arms 5A and 5B to extend forwards of the front pivot points 7A and 7B.

In addition to guiding and providing structural support to the moving parts of the standing assist device 1, the upper and lower side support arms 5A and 5B can provide a hand grip and convenient lateral support for the user while in the act of making the transition between a standing and a seated position.

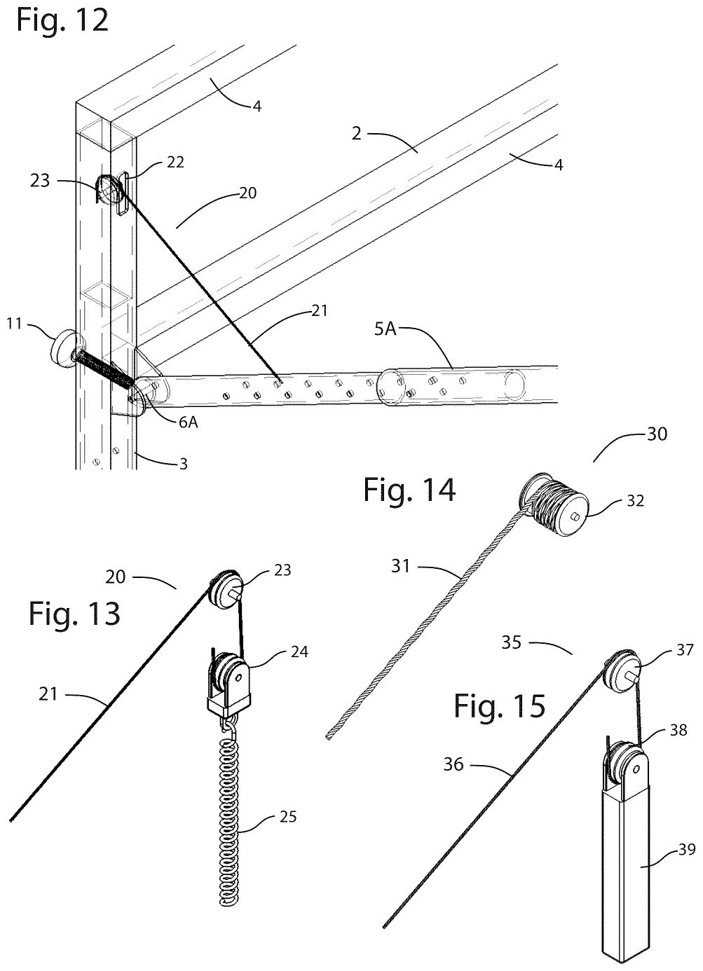

The standing assist device 1 may include one or more counterbalance mechanisms to reduce the force required by a user when raising and lowering the side support arms 5A and 5B, the front legs 8, and any other structures attached to these movable components. FIG. 12 is an enlarged axonometric view of one corner of the rear support frame 2 of the embodiment of FIG. 1 showing one example of a counterbalance mechanism 20. In this example, a flexible tension member 21, such as a wire, a rope, a line, an elastic band, or a chain, has one end secured to one of the side support arms 5A or 5B. The tension member 21 extends through an opening 22 in one of the legs 3 of the rear support frame 2, and a tensile force is applied to the tension member 21 to counterbalance the weight of the movable portions of the standing assist device 1.

FIGS. 13-15 are axonometric views of examples of various structures which can employed to apply a tensile force to the tension member 21. In the example of FIG. 13, the tension member 21 passes over a first pulley 23 mounted inside one of the legs 3 of the rear support frame 2 and then passes around a second pulley 24 which is suspended within the leg 3. The end of the tension member 21 is secured to the interior of the leg 3 of the rear support frame 2. A tension spring 25 is disposed inside the leg 3 with its upper end connected to the second pulley 24 and its lower end secured to the interior of the leg 3. The tension spring 25 applies a downwards force on the second pulley 24, which applies a tensile force to the tension member 21. In an alternative construction, the tension spring 25 could pull directly on the end of the tension member 21.

FIG. 14 shows an example of a counterbalance mechanism 30 having a conventional spring reel 32 mounted inside a leg 3 of the rear support frame 2 and a tension member 31 which is wrapped around and secured to the reel 32. An unillustrated internal spring inside the spring reel 32 applies a torque to the spring reel 32 which applies tension to the tension member 31, and the tension member 31 in turn applies a force to the corresponding side support arm 5A or 5B, thereby urging the side support arm to rotate towards its raised position.

FIG. 15 shows an example of a counterbalance mechanism 35 having a tension member 36 which passes around a first pulley 37 and a second pulley 38 disposed inside a leg 3 of the rear support frame 2. The end of the tension member 36 is secured inside the leg 3 of the rear support frame 2. In place of the tension spring 25 of FIG. 13, a counterweight 39 is secured to the second pulley 38 to apply tension to the tension member 36.

While FIG. 12 shows only one of the widthwise sides of the rear support frame 2, a counterbalance mechanism will typically be installed on both widthwise sides of the rear support frame 2.

Although the examples of counterbalance mechanisms 20, 30, and 35 shown in FIGS. 12-15 are installed inside the legs 3 of the rear support frame 2, they could instead be installed on the exterior of the rear support frame 2.

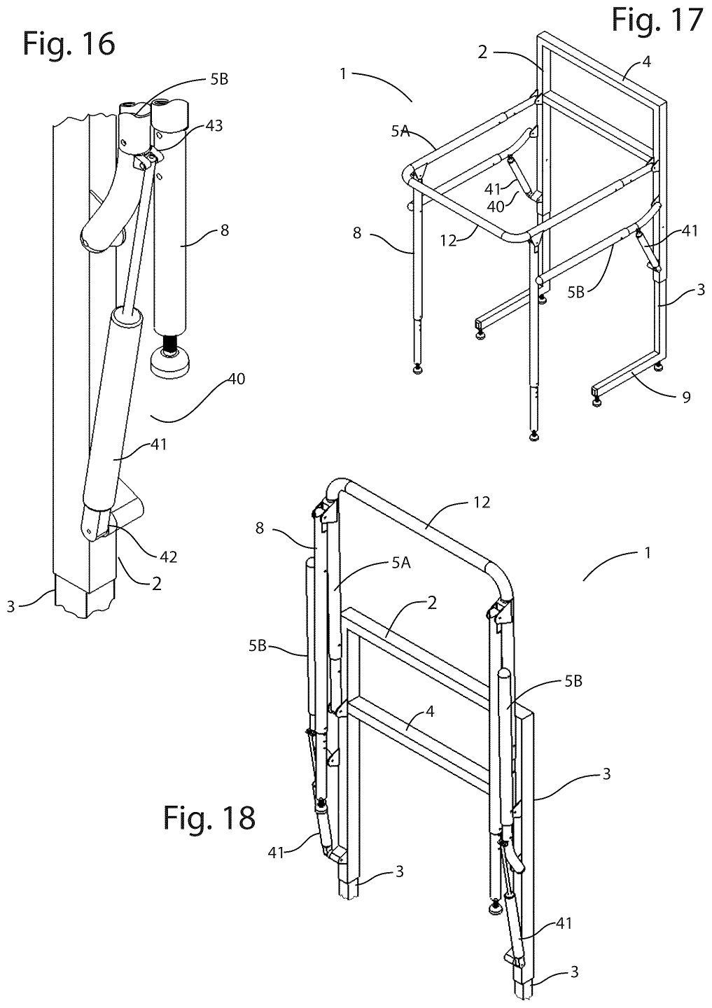

FIGS. 16-18 show axonometric views of another example of a counterbalance mechanism 40 which can be employed in the present invention. The counterbalance mechanism 40 in this example comprises conventional gas springs 41 mounted on both widthwise sides of the exterior of the standing assist device 1. The gas springs 41 may be commercially available items such as are commonly used to support the hoods, trunks, or hatchback doors of automobiles. In the example shown in detail in FIG. 16, each of the gas springs 41 has a lower end 42 pivotably connected to one of the legs 3 of the rear support frame 2 and an upper end 43 pivotably connected to one of the lower side support arms 5B, but the gas springs 20 could instead be connected to the upper side support arms 5A.

As an alternative, counterbalancing of the weight of the moving portions of the standing assist device 1 could be achieved by incorporating one or more torsion springs in the hinges at points A or D (shown in FIG. 7) between either the upper or lower side support arms 5A and 5B and the rear support frame 2.

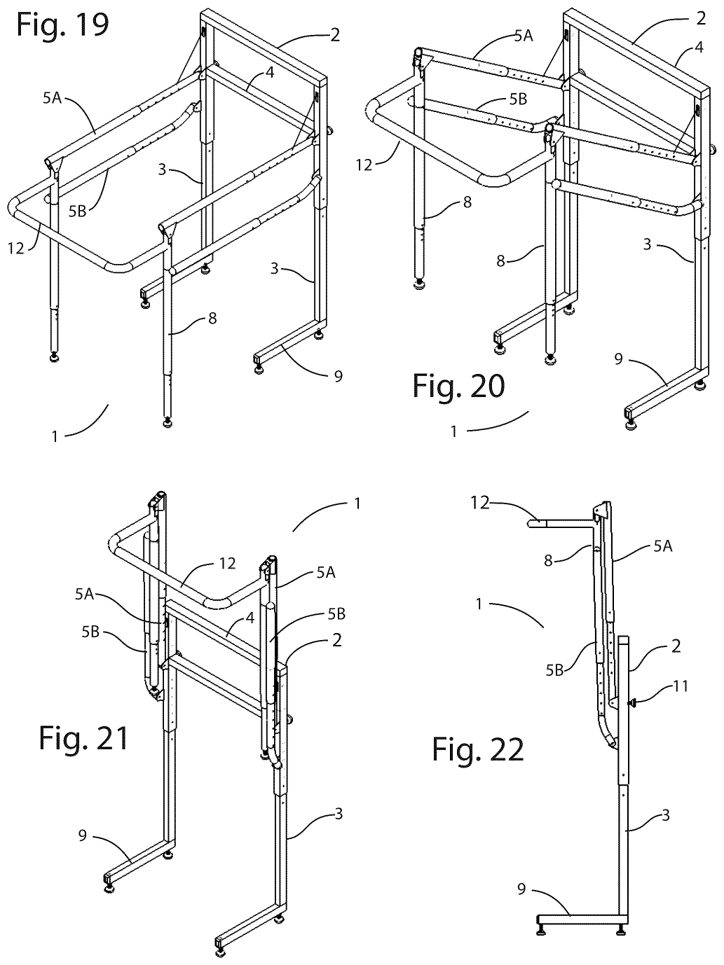

The standing assist device 1 may include one or more transverse connecting members 12 which extend between opposite widthwise sides of the standing assist device 1 in the vicinity of the front end of the standing assist device 1. A transverse connecting member 12 can serve various functions. It can provide rigidity to the standing assist device 1 and ensure that the side support arms 5A and 5B and the front legs 8 on the left and right widthwise sides of the standing assist device 1 can be raised and lowered simultaneously. It can also serve as a location which can be grasped by a user of the standing assist device 1 when standing up or sitting down or when standing in a stationary position. A transverse connecting member 12 can be secured to various portions of the standing assist device 1. In the example shown in FIG. 1, each end of the transverse connecting member 12 is secured to the front end of one of the side support arms 5, such as the upper side support arms 5A in FIG. 1. Alternatively, FIGS. 19-22 show an example of a standing assist device 1 in which each end of a transverse connecting member 12 is secured to one of the front legs 8 of the standing assist device 1. In the arrangement shown in FIG. 1, if the transverse connecting member 12 extends forwards of the upper side support arms 5A when the upper side support arms 5A are in a lowered position, the transverse connecting member 12 will extend above the upper side support arms 5A when the side support arms are in a fully raised position (as shown in FIGS. 5 and 6) thereby increasing the overall height of the standing assist device 1.

In contrast, in the arrangement of FIGS. 19-22, assuming that the side support arms 5A and 5B are part of a parallelogram linkage, the transverse connecting member 12 will maintain a constant attitude with respect to the horizontal as the side support arms 5A and 5B are pivoted upwards. As a result, even if the transverse connecting member 12 extends forwards of the side support arms 5A and 5B when the side support arms 5A and 5B are in a lowered position as shown in FIG. 19, the transverse connecting member 12 will maintain the same attitude with respect to the horizontal as shown in FIG. 20 when the side support arms 5A and 5B are in a partially raised position, as shown in FIG. 20 and when the arms 5A and 5B are in the fully raised position as shown in FIGS. 21 and 22. As seen in the side elevation of FIG. 22, the transverse connecting member 12 produces no increase in the height of the standing assist device 1 in this configuration.

The height of the transverse connecting member 12 and its distance from the rear support frame 2 are chosen so that when a user is standing inside the standing assist device 1 between the left and right pairs of side support arms 5A and 5B, the transverse connecting member 12 will preferably travel along a path passing above the head of the user without contacting the head of the user when the side support arms 5A and 5B are raised from a lowered position to a raised position or vice versa so that the user will not need to crouch or otherwise move to avoid contact of the transverse connecting member 12 with his or her head.

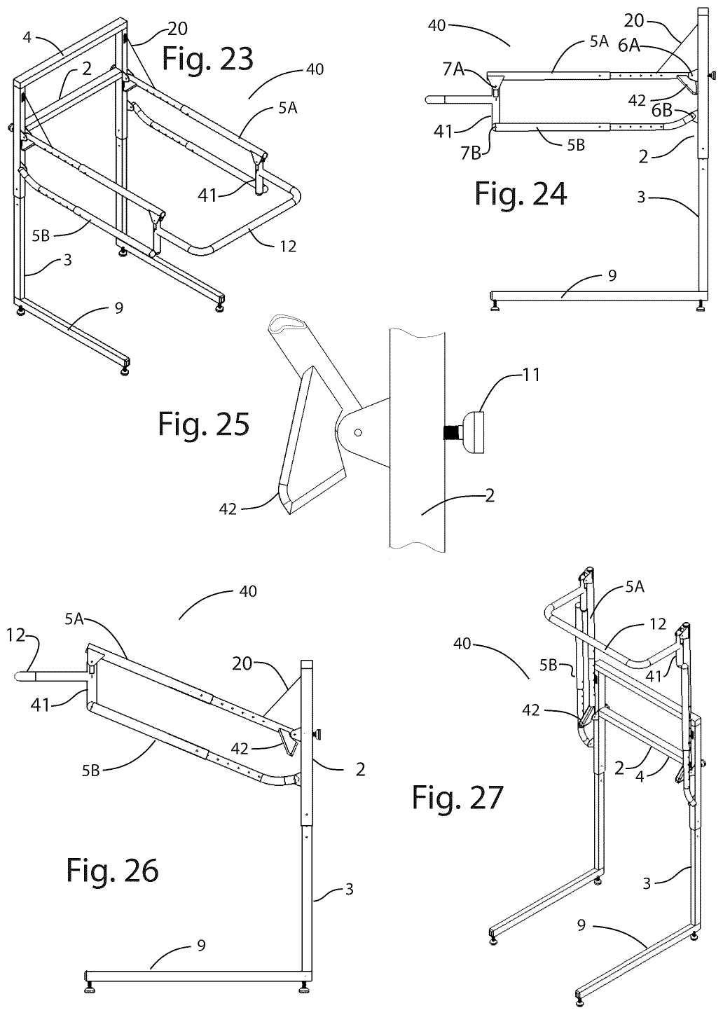

FIGS. 23-27 illustrate another embodiment of a standing assist device 40 according to the present invention. In this embodiment, the front legs 8 of the standing assist device 1 of FIG. 1 have been omitted.

The overall structure of this embodiment is similar to that of the embodiment of FIG. 1. It includes a rear support frame 2 and two pairs of upper and lower side support arms 5A and 5B pivotably mounted on opposite widthwise sides of the rear support frame 2 at upper and lower pivot points 6A and 6B for pivoting between a lowered position shown in FIGS. 23 and 24, a partially raised position shown in FIG. 26, and a fully raised position shown in FIG. 27. The front ends of the upper and lower side support arms 5A and 5B are each pivotably connected to the upper and lower ends of a short link member 41 at upper and lower pivot points 7A and 7B. Each link member 41 functions as a component of a four-bar linkage including the link member 41, the upper and lower side support arms 5A and 5B to which it is connected, and the portion of the rear support frame 2 between pivot points 6A and 6B. The four-bar linkage may have any of the geometries described above with respect to the embodiment of FIG. 1, such as any of the geometries illustrated in FIGS. 8-11.

A transverse connecting member 12 extends between and is secured to the two link members 41, but the transverse connecting member 12 may instead be secured to the side support arms 5A or 5B. One or more stoppers 42, such as the one shown in FIG. 25, may be provided to support the side support arms 5A and 5B in their lowered position in the absence of the front legs 8. For example, as shown in FIG. 25, a stopper 42 may be secured to each of the upper side support arms 5A in a location such that the stopper 42 will abut against the rear support frame 2 when the side support arms 5A and 5B are in a lowered position. Alternatively, stoppers 42 may be provided on the rear support frame 2 for abutment with the side support arms 5A and 5B when the side support arms 5 are in a lowered position. As another alternative, stopping of the rotation of the side support arms 5A and 5B can be provided by travel limitations built into a counterbalance mechanism 20. Omission of the front legs 8 from a standing assist device 1 can be useful when the standing assist device is to be used in a location having obstructions on the floor which could interfere with the front legs 8.

In the embodiment of FIG. 1, when the front legs 8 have an upper section and a removable lower section (such as the telescoping structure shown in FIG. 1), a structure similar to that shown in FIGS. 23-27 could be achieved by disconnecting the lower section of each front leg 8 from the upper section.

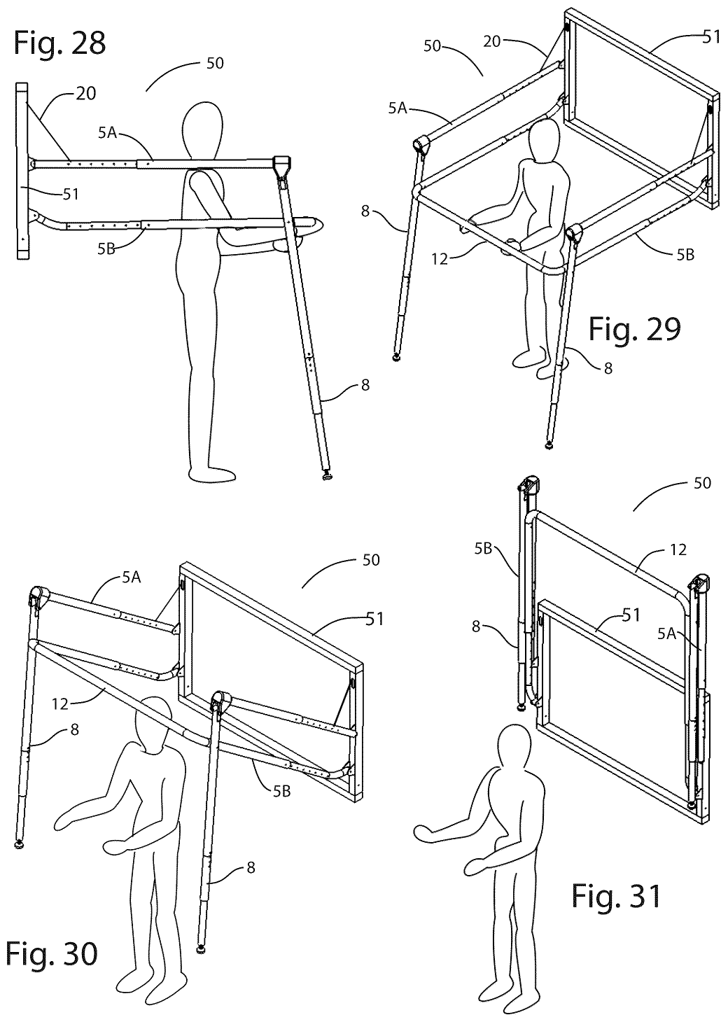

In some situations, it may be advantageous to mount a standing assist device directly to a wall and eliminate the portions of the rear support frame resting on the ground. FIGS. 28-31 illustrate an embodiment of a wall-mounted standing assist device 50.

FIG. 28 is a schematic side elevation of the standing assist device 50 in a lowered position, FIG. 29 is a schematic axonometric view of the standing assist device 50 in the lowered position, FIG. 30 is a schematic axonometric view of the standing assist device 50 in a partially raised position, and FIG. 31 is a schematic axonometric view of the standing assist device 50 in a fully raised position. An example of the location of a user of the device 50 during its operation is shown in outline.

In this embodiment, the standing assist device 50 includes a wall-mounted rear support frame 51 without any legs extending to the floor. The rear support frame 51 is illustrated as a rectangular member resembling a picture frame, but the shape of the rear support frame 51 is not restricted. For example, the rear support frame 51 could be formed by removing the lower portions of the legs 3 from the rear support frame 2 in the embodiment of FIG. 1. As in the previous embodiments, a pair of side support arms 5A and 5B is pivotably mounted on the rear support frame 51 on opposite widthwise sides of the standing assist device 50, and the front ends of each of the side support arms 5A and 5B are pivotably connected to a front leg 8 to define a four-bar linkage. The rear support frame 51 can be rigidly secured to a wall using bolts, screws, or other means. Although the standing assist device 50 shown in FIGS. 28-31 includes front legs 8, the front legs 8 could be omitted in the same manner as in the embodiment of FIGS. 23-27. The operation of this embodiment is essentially the same as that of the preceding embodiments.

A wall-mounted standing assist device can be advantageous when there are obstructions on a wall or floor which would interfere with the placement of the legs of a rear support frame. In addition, when the standing assist device does not include front legs, such as in the embodiment of FIGS. 23-27, a wall-mounted rear support frame can provide additional stability to the standing assist device which would otherwise be provided by the front legs.

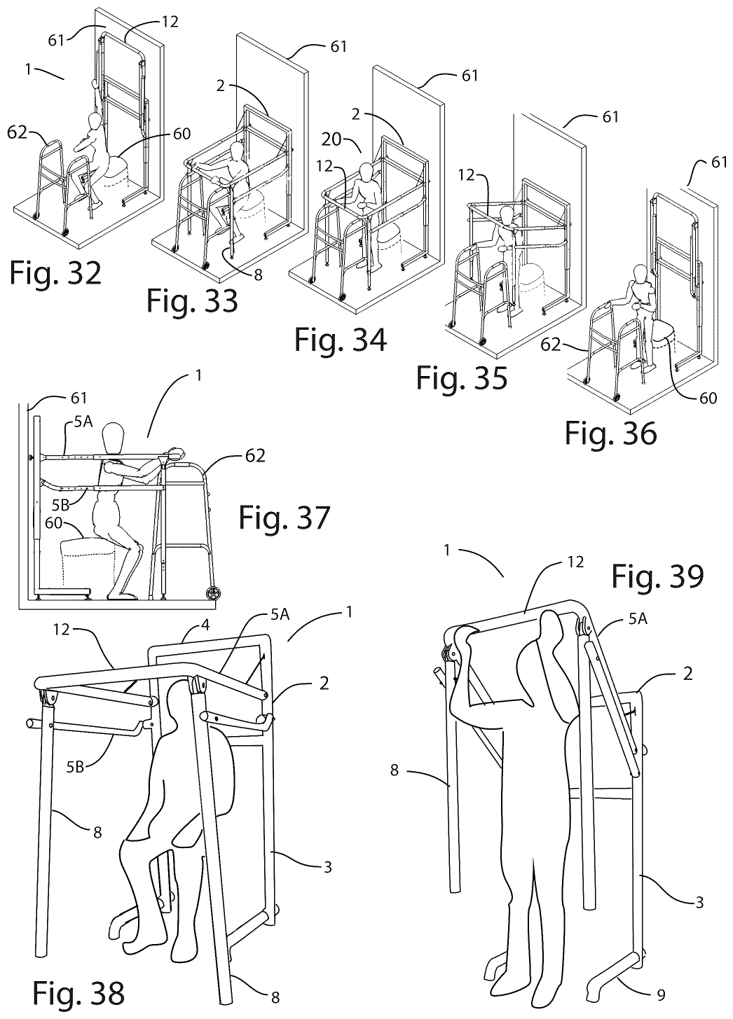

FIGS. 32-42 illustrate an example of using a standing assist device according to the present invention. The standing assist device shown in these figures is the standing assist device 1 described above with respect to FIG. 1, but the same method of use can be employed with any of the other embodiments of a standing assist device according to the present invention.

In FIGS. 32-38, a user is shown sitting on a seat 60 with his back facing a wall 61. The seat 60 is generically illustrated and could represent a wide variety of typical seats such as a chair for watching TV, a toilet, or other sitting surface. The standing assist device 1 is shown resting on the floor and placed with the rear support frame 2 of the standing assist device 1 against the wall 61 and behind the user. In FIG. 32, the standing assist device 1 is shown in the stowed position as it would normally be left prior to use, with the side support arms 5A and 5B and the front legs 8 in a fully raised and out of the way position. When the user desires to stand up, the side support arms 5A and 5B are rotated, either by the user or by an aide, to a lowered position in which the front legs 8 rest on the floor as shown in FIG. 33. As shown in FIG. 32, the user could, for example, reach back and grasp either a leg 8 or one of the side support arms 5A or 5B to pull the moving portions of the device 1 from their stowed position against the wall 61 down into the lowered position shown in FIGS. 33, 34, 37, and 38. As shown in FIG. 33, the user then grasps some convenient portion of the standing assist device 1 located in front or beside his body. In this figure, the user is shown grasping the transverse connecting member 12 of the standing assist device 1, but any portion of the standing assist device 1 which the user can comfortably grasp is acceptable, such as the side support arms 5A or 5B or one of the front legs 8. The portion of the standing assist device 1 grasped by the user is preferably located far enough in front of the seat 60 that the user will need to lean forward in his seat in order to grasp the location and thereby bring his center of gravity forwards. The portion of the standing assist device 1 grasped by the user is also preferably no lower than the height of the user's shoulders so that when the user is grasping this portion and pulling with his arms, the force exerted by the user will have an upwards component which will help the user to stand up. The height of the portion grasped by the user and its distance from the rear support frame 2 can be adjusted in accordance with the size of the user by varying the lengths of various members of the standing assist device 1 such as the side support arms 5A and 5B, the front legs 8, or the rear support frame 2.

From the seated position shown in FIGS. 33, 37, and 38, the user can bring himself to a standing position as shown in FIG. 34 by pulling with his arms and simultaneously pushing with his legs. In contrast to typical wall-mounted or toilet-mounted grab bars, which a user must release in order to stand upright, the transverse connecting member 12 of the standing assist device 1 is sufficiently high off the ground that the user can support himself in a standing position while still holding onto the transverse connecting member 12.

If the user normally employs some sort of support device 26 to help him walk, such as a walker 62 or a cane, the walker 62 or other support device can be placed in front of the user (either by the user or by an aide), and the user can transfer his hands from the standing assist device 1 to the walker 62 as shown in FIG. 34. The transverse connecting member 12 of the standing assist device 1 is preferably high enough off the floor that a typical walker 62 can be disposed between the front legs 8 of the standing assist device 1 with the standing assist device 1 still in a lowered position.

With the user standing inside the standing assist device 1 between the left and right widthwise sides of the standing assist device 1, the standing assist device 1 can then be raised from a lowered position to a raised position as shown in FIGS. 35, 36, and 39. Depending upon the weight of the side support arms 5A and 5B and the front legs 8, they can be moved from a lowered position to a fully raised position either by the user or by an aide. The counterbalance mechanism 20 facilitates this process by greatly reducing the effort needed to raise or lower the moving parts of the standing assist device 1. Further, the counterbalance mechanism 20 holds the standing assist device 1 in the raised position, ensuring that the device 1 won't accidentally drop into a lowered position. As shown in FIGS. 35 and 39, the distance of the transverse connecting member 12 from the rear support frame 2 is preferably such that the transverse connecting member 12 can easily pass above the head of a standing user as the standing assist device 1 is raised from the lowered position. Once the standing assist device 1 is in the fully raised position shown in FIG. 36, the user is free to walk away from the seat 60.

In each of the states illustrated in FIGS. 32-39, all vertical forces applied to the standing assist device 1 by the user are transmitted to the floor by the rear support frame 2 through the feet 9 and/or the front legs 8 of the device 1, and any horizontal forces applied to the standing assist device 1 by the user are transmitted to the wall 61 behind the standing assist device 1 as compressive forces, which can easily be borne by the wall 61. No moments are applied to the wall 61 by the standing assist device 1, so the standing assist device 1 can be installed wherever a convenient wall is available and can easily be moved to different locations.

The standing assist device 1 can be used to assist a user in sitting down on a seat 60 by essentially the same steps shown in FIGS. 32-39 performed in the reverse order. Namely, in this case, the user stands in front of a seat 60 with his back to the seat 60 as shown in FIG. 36, the standing assist device 1 is lowered over the user to a lowered position as shown in FIGS. 32, 33, 34, 37, and 38, the user sits down while aided by holding onto the standing assist device 1 as shown in FIG. 33, and then the standing assist device 1 is moved out of the way to a raised position to achieve the configuration shown in FIG. 32.

FIG. 40 illustrates an example in which a standing assist device 1 according to the present invention can assist a user to sit down on or get up from a sofa 63. The standing assist device 1 is disposed with the rear support frame 2 to the rear of the sofa 63 and is prevented from moving backwards with respect to the sofa 63 either by being placed against a wall, by being attached to the sofa 63, or by being restrained by another stationary object such as a heavy piece of furniture and with the side support arms 5A and 5B extending toward the front of the sofa 63. When the standing assist device 1 is in a lowered position, the front legs 8 rest on the floor in front of the sofa 63. The user can use the standing assist device 1 in essentially the same manner as shown in FIGS. 32-39.

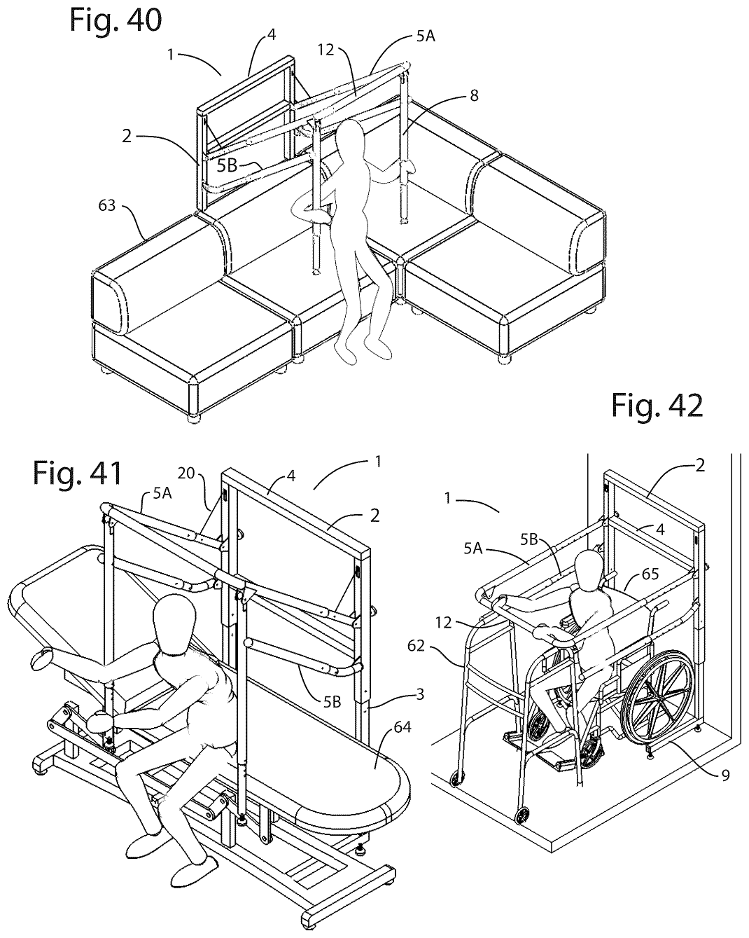

FIG. 41 illustrates an example in which a standing assist device 1 according to the present invention is used in conjunction with an examination table 64, such as those found in hospitals or clinics. The standing assist device 1 is disposed alongside the length of the examination table 64, with the side support arms 5A and 5B extending in the widthwise direction of the examination table 64 and with the front legs 8 resting on the floor alongside the table 64 when in a fully lowered position. The rear support frame 2 can be installed against a wall or secured to the examination table 64. The standing assist device 1 can be used in a similar manner with respect to a massage table, an exercise table, a hospital bed, a bed in a home, a cot, or the like. In some situations, the standing assist device 1 can be anchored to the floor or another structure.

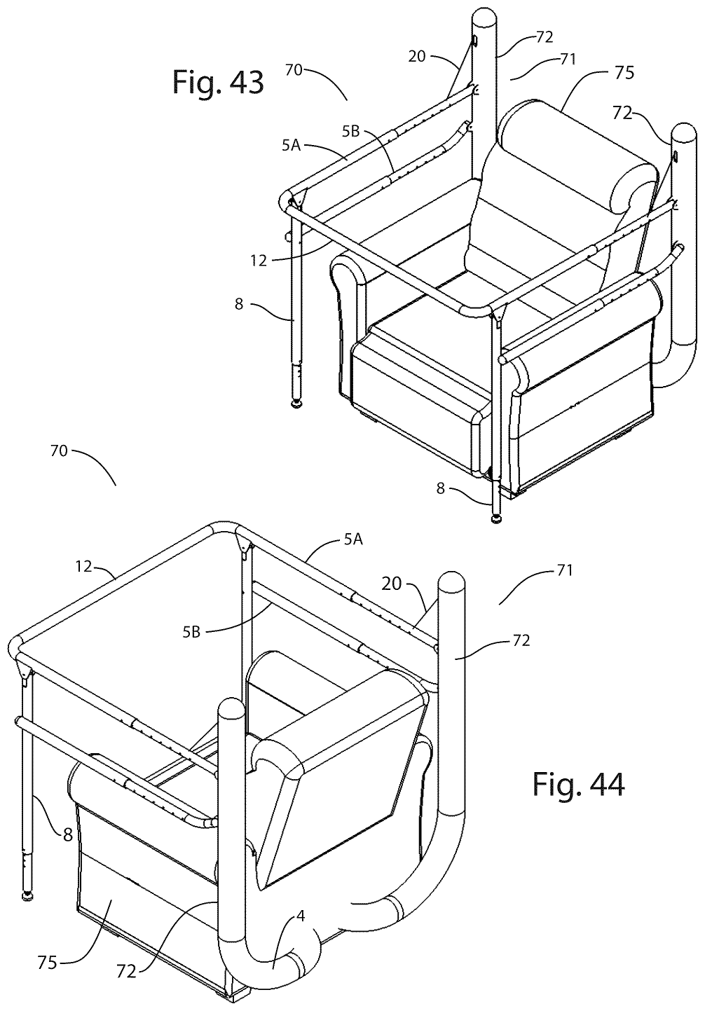

FIG. 42 illustrates how a standing assist device 1 can be used to facilitate, for example, transfer of a user from a wheelchair 65 to a walker 62. The user could simply back the wheelchair 65 between the feet 9 of the standing assist device 1 while it is in the stowed upright position. The user could then reach back and lower the standing assist device 1 and then grab and pull on the transverse connecting member 12 to assist as described before in making the transition to the walker 62. In FIG. 42, the front legs 8 of the standing assist device 1 have been omitted for clarity.

Although FIGS. 40 to 42 illustrate the use of the standing assist device 1 of FIG. 1, any of the other embodiments of a standing assist device according to the present invention can be used in a similar manner.

FIGS. 43 and 44 schematically illustrate an embodiment of a standing assist device 70 which has been integrated with a chair 75, such as a recliner or an easy chair. The moving portions of the standing assist device 70 are the same as described earlier with respect to FIG. 1, but the rear support frame 2 of that embodiment has been replaced by a rear support frame 71 which is mounted on the chair 75. In this example, the rear support frame 71 comprises two posts 72 having lower ends which are rigidly secured to the back or frame of the chair 75 and which extend upwardly, such as vertically. on opposite widthwise sides of the chair 75. The rear ends of side support arms 5A and 5B are pivotably connected to each post 72 on opposite widthwise sides of the chair 75, and the front ends of the side support arms 5A and 5B are pivotably connected to front legs 8 to define a four-bar linkage on each widthwise side of the chair 75. The structure of the standing assist device 70 is otherwise the same as that of the embodiment of FIG. 1, although it is also possible for it to employ the structure of any of the other preceding embodiments.

It is also possible for a rear support frame of a standing assist device according to the present invention to be integrated with the structure of a bed frame, a sofa, or other heavy article of furniture.

What is claimed is:

1. A standing assist device comprising:
a rear support frame;
first and second 4-bar linkages disposed on opposite widthwise sides of the support frame and defining a space between the 4-bar linkages in which a user of the device can sit, each of the 4-bar linkages including first and second side support arms each having a rear end pivotably connected to the rear support frame and a front end, the side support arms being pivotable with respect to the rear support frame between a raised position and a lowered position; and
a transverse connecting member extending in a widthwise direction of the standing assist device and connecting the first and second 4-bar linkages.

2. A standing assist device as claimed in claim 1 including first and second front legs, each of which is pivotably connected to two of the side support arms and forms a portion of one of the 4-bar linkages and which contacts a floor when the side support arms are in the lowered position.

3. A standing assist device as claimed in claim 1 including structure for limiting rotation of the side support arms beyond the lowered position.

4. A standing assist device as claimed in claim 1 wherein the side support arms are substantially horizontal when in the lowered position.

5. A standing assist device as claimed in claim 1 wherein each of the 4-bar linkages comprises a parallelogram linkage.

6. A standing assist device as claimed in claim 1 wherein each of the 4-bar linkages comprises a trapezoidal linkage.

7. A standing assist device as claimed in claim 2 wherein at least one of the rear support frame, the side support arms, and the front legs has an adjustable length.

8. A standing assist device as claimed in claim 1 wherein the rear support frame has legs for transmitting the weight of the rear support frame to a floor.

9. A standing assist device as claimed in claim 1 including a counterbalance mechanism connected between the rear support frame and one of the 4-bar linkages.

10. A standing assist device as claimed in claim 1 wherein the rear support frame is mounted on a wall.

11. A standing assist device as claimed in claim 1 wherein the transverse connecting member is secured to one of the side support arms of each 4-bar linkage.

12. A standing assist device as claimed in claim 2 wherein the transverse connecting member is secured to the two front legs.

13. A standing assist device as claimed in claim 2 wherein the transverse connecting member extends forwards beyond the front ends of the side support arms.

14. A standing assist arrangement comprising:
the standing assist device of claim 1; and
a seat for a user disposed in front of the rear support frame between the two pairs of side support arms.

15. A standing assist arrangement as claimed in claim 14 wherein the seat is selected from a chair, a stool, a bench, a sofa, a bed, a wheelchair, an examination table, and a toilet.

16. A standing assist arrangement as claimed in claim 14 wherein the rear support frame sits on a floor against a wall.

17. A standing assist arrangement as claimed in claim 14 wherein the rear support frame is supported by the seat.

18. A method of assisting a user in standing from a seated position comprising:
disposing a user in a seated position on a seat in front of the rear support frame of the standing assist device of claim 1 with the user facing away from the rear support frame and with the side support arms in a raised position;
lowering the side support arms while passing the transverse connecting member over the head of the user; and
having the user grasp a portion of the standing assist device located forwards of the rear support frame and pull himself to a standing position; and raising the side support arms from the lowered position to the raised position with the transverse connecting member passing over the head of the user.

19. A method as claimed in claim 18 including having the user grasp the standing support device at a height greater than his center of gravity.
